(19) United States
(12) Patent Application Publication
(10) Pub. No.: US 2008/0251491 A1
(43) Pub. Date: Oct. 16, 2008

(54) Closure with Oxygen Absorption

(76) Inventor: Gunter Krautkramer, Budenheim (DE)

Correspondence Address: PAUL AND PAUL, 2000 MARKET STREET, SUITE 2900, PHILADELPHIA, PA, 19103, US

(21) Appl. No.: 11/568,780

(22) PCT Filed: Sep. 29, 2004
(86) PCT No.: PCT/EP04/52345

§ 371 Date: Dec. 11, 2006

(30) Foreign Application Priority Data
May 7, 2004 (DE) 10 2004 022 715.2

(51) Int. Cl. B23P 17/00; B65D 53/00

(52) U.S. Cl. 215/341; 29/527.3

(57) ABSTRACT

The invention relates to a closing cap (1) for containers, which comprises a cylindrical cap jacket (2) and a cap base (3) and an annular circumferential seat (5, 6) extending from the inner surface of the cap and provided to sealingly engage with a container neck, whereby the annular circumferential seal is configured as an integral part of the closing cap. The aim of the invention is to provided closure of the aforementioned kind which, like conventional one-part closures, is easy to produce and handle and has oxygen absorption properties. For this purpose, the inner surface of the cap base (3) is coated with an oxygen absorption compound radically inside the annular circumferential seal (5, 6) said compound consisting of a material that is chemically related to the material of the closure.

The present invention relates to a closure cap for containers, consisting of a cylindrical cap casing and a cap base as well as an annular seal extending from the inner surface of the cap for sealing engagement with a container neck, wherein the annular seal is formed in one piece with the closure cap.

Corresponding closure caps have already long been known in the state of the art as so-called “one-piece closures”.

Furthermore, two-part closures are also known in the state of the art in which additional sealing elements are introduced or inserted into a closure cap which consists substantially of only a cap casing and a cap base without moulded-on sealing elements. In general, these sealing elements are introduced in the form of a sealing disk or sealing film inserted into the cap base, which are composed of a material with good sealing properties such as e.g. PVC, whereas the corresponding closure caps are mostly made of a different material such as e.g. polyethylene or polypropylene.

It is also known of the closures with additionally inserted seal that the seal is composed of an oxygen-absorbing material or has a layer of an oxygen-absorbing material.

However, the disadvantage of closures with additionally inserted seal is that they are relatively difficult to manufacture and handle. In most cases, the sealing materials adhere only very poorly to the material of the closures and must be secured with the help of an appropriate adhesive or else the closure must have corresponding undercuts in order to lock a sufficiently rigid sealing disk behind. However, such closures are unsuitable in the aseptic field or they are even more complicated to handle. In the aseptic field, the corresponding closure caps, before being fitted to containers (for example for fruit juices), are as a rule cleaned with a sterile or disinfectant fluid which in most cases is sprayed into the cap under a pressure of between say 1 and 3 bar. If the sealing disk is loose, the cleaning fluid can penetrate between sealing disk and closure and remains there and can thereby also contaminate the product. Alternatively, sealing disks the full surfaces of which are glued in must be handled while sterile, wherein gluing-in under sterile conditions is extremely difficult.

In contrast, closure caps onto which corresponding seals have been moulded in one piece have considerable advantages in production and handling, including under sterile conditions.

However, some products whose containers are sealed with corresponding closure caps are very sensitive to oxygen, and it is not necessarily enough for the closure to seal sufficiently tightly and also to allow little if any oxygen diffusion, as the atmospheric oxygen also trapped during the sealing of the container is enough to have harmful effects on the product. In such cases it is desirable for a closure to be able to absorb oxygen to a certain extent. In the case of seals with additionally inserted or glued-in sealing disks, this was relatively easy to achieve by making the sealing disks from an oxygen-absorbing material.

Compared with the above-named state of the art, the object of the present invention is to create a closure with the features named at the outset which, like the known one-piece closures, is simple to produce and easy to handle and yet has oxygen-absorbing properties.

This object is achieved in that the inner surface of the cap base is covered radially inside the annular seal with an oxygen-absorbing compound which is composed of a material chemically related to the material of the closure. Preferred materials for corresponding one-piece closures are for example polyethylene and polypropylene. Consequently, the corresponding compound should also be composed predominantly of polyethylene or polypropylene but to which in addition an oxygen-absorbing substance has also been added or compounded, wherein it is understand that the material directly absorbing the oxygen must be compatible with the main constituent or matrix constituent of the compound (thus e.g. polyethylene or polypropylene). Because of the chemical relationship between closure material and oxygen-absorbing compound, it is possible to combine these materials relatively easily even without adhesive by adhesion forces alone with the result that firstly a tight closure forms between the compound and the cap and thus also no cleaning fluid can penetrate the area between compound and closure material during cleaning. Moreover, the compound is freed from any sealing tasks, with the result that the composition of the compound can be selected solely according to the desired main properties, namely oxygen absorption and the good and secure adhesion to the material of the closure.

The sealing is carried out completely independently of the compound by the sealing elements moulded in one piece onto the closure.

Apart from the somewhat greater difficulty in the production of such a closure, this closure can also be handled in sterile applications in exactly the same way as the known one-piece closures and can in particular also be sterilized with a cleaning fluid before being fitted to a container. No cleaning fluid at all can penetrate between the compound applied securely to the inner surface of the cap or cap base and the cap material underneath.

In the preferred embodiment, the closure has a substantially hollow cylindrical, axially-extending centring pin which is provided to extend into a container neck for the purpose of centring the caps, wherein the compound is then restricted substantially to the cap area radially inside this centring pin or centring journal.

However, a variant of the invention is preferred in which the cylindrical inner surface of such a centring pin is also substantially completely covered by the compound. It is furthermore expedient if the free end of this centring pin has on its inside dimensional graduations or a gradually increasing diameter and the oxygen-absorbing compound extends into this graduated area or up to the free end of the centring pin in order to thus form a labyrinth-like seal between compound and closure material in order to avoid the entry of cleaning fluid or in general also of any other fluids in the area between compound and closure material, particularly when the adhesion between the compound material and the material of the remaining closure is not particularly strong.

In the preferred embodiment of the invention, the centring pin is formed as an internal seal, i.e. it is dimensioned and shaped such that it is in sealing engagement with the cylindrical inner surface of the container neck while and after being fitted to a corresponding container neck. For this purpose, a version of the centring pin is particularly preferred in which this centring pin has on its outside a projection which restricts the sealing engagement to a linear or narrow strip-shaped area defined by the specific cross-section shape and the elastic deformation of same, with the result that in this area a higher compression contact is achieved than with a sealing engagement covering a large area.

Furthermore, in the preferred embodiment of the invention, independently of the centring pin and preferably also when the centring pin is formed as an internal seal, a further seal is provided in the form of a substantially axially extending, annular (i.e. substantially hollow cylindrical) sealing pin which enters into sealing engagement with the end-surface of the bottle and/or with the upper edge or the outer surface of same bordering the upper edge of the container neck.

If the adhesion between compound material and closure material is only relatively weak, it can also be expedient for the cap base to have projections and/or recesses which have undercuts in axial direction, but these undercuts are however so small that the closure can still be axially demoulded from a corresponding injection mould without difficulty. These recesses and/or projections on the cap base in the area of the compound ensure an additional form-locking adhesion of the compound to the closure cap and more precisely to the cap base.

Expediently for this purpose, an annular projection which has a substantially swallowtail cross-section is provided on the cap base.

In a preferred embodiment of the invention, the cylindrical inner surface of the sealing pin advantageously has a corrugation by which the connection between the oxygen-absorbing coat and the sealing pin becomes even more secure. Optionally, the inner surface of the cap base could also be roughened or provided with a corresponding corrugation.

It is furthermore advantageous if in a preferred embodiment of the invention the coat also extends in axial direction somewhat beyond the free end of the sealing pin and in radial direction covers the free end of the sealing pin. In this way, not only is a further improved connection achieved between cap and coating, but rinsing fluid is also particularly effectively prevented, when rinsing out the cap, for example in the case of aseptic packages, from penetrating between the boundary surfaces of sealing pin and coating, which could otherwise lead to a partial detachment of the coating from the inner surface of the cap or sealing pin.

In the preferred embodiment of the invention, the closure cap also has an internal thread for the screwing engagement with the corresponding thread of a container neck and in addition at its lower edge also an encircling guarantee strip which tears when the closure is unscrewed for the first time so that the user or consumer can tell whether the container is being opened for the first time or has already been previously opened.

The present invention also relates to a process for the production of a corresponding closure in which firstly a closure cap with at least one annular seal moulded on in one piece is produced by injection-moulding. Regarding the process for the production of a closure which achieves the object outlined above, it is proposed according to the invention that, following the production by injection-moulding, a predetermined quantity of an oxygen-absorbing compound which is composed substantially of a material chemically related to the material of the closure is applied to the cap base in a hot, plastic state and placed under pressure by a mould force engaging in the cap and thereby moulded to the inner contour of the cap inside the annular seal.

This is a relatively simple process that is easy to carry out and the cap can then be handled like a conventional, one-piece closure cap.

In the preferred version of the named process in which the compound also comes into contact with the sealing or centring elements in the cap, it is provided according to the invention that such centring or sealing elements are fixed or supported by an additional holder introduced together with or prior to the mould force. In this way, by compressing the hot compound material, which is also applied for example to the inner surface of a centring journal or a corresponding internal seal, such a centring journal or such an internal seal is prevented from being excessively deformed with the result that the closure would then possibly no longer have the desired dimensions to be able to be easily fitted to a container neck.

In addition to the use according to the invention of polyethylenes for the manufacture of both closure cap and compound, the use according to the invention of polypropylenes for the manufacture of both closure cap and compound is also possible. In addition, the principle of the use according to the invention of products which come from the same chemical family (e.g. polyethylenes, polypropylenes) for the manufacture of both closure cap and compound can also be applied to other chemical product families that come into consideration for the production of closure caps and compounds.

Expediently, the compound is introduced such that it extends at least over the cap base. In a preferred embodiment of the present invention, the compound is introduced such that the surface of the cap base covered by the compound is extended to cover the inner cylindrical surface of the internal sealing element. Consequently the whole interior of the closure cap inside the inner, axial sealing pin, including the cap base and the inside of the axial sealing pin, is lined with the compound. The adhesion improved according to the invention between compound material and closure cap material is advantageous as it thereby becomes possible to extend the application of compound to the inside of the internal seal and thereby firstly to introduce more compound material into the closure caps; secondly, a desirable surface enlargement of the introduced compound material thereby takes place.

The surface enlargement according to the invention of the compound material can be advantageous for example with regard to specific oxygen-binding active ingredients in the closure cap/compound system, but the application of the present invention is not to be limited to the use in combination with such oxygen-binding active ingredients. In a particularly preferred embodiment of the invention, the introduced compound contains one or more oxygen-binding active ingredients among others.

Further advantages, features and possible applications of the present invention are shown in the following description of a preferred embodiment and the associated figures. There are shown in:

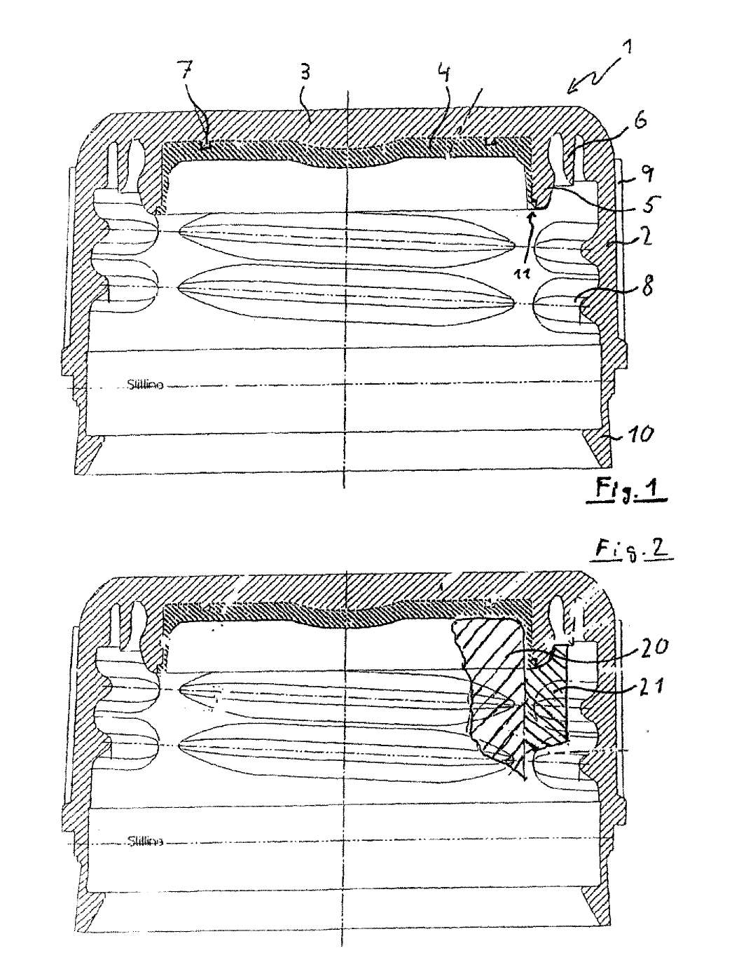

FIG. 1 an axial section through a closure according to the invention and

FIG. 2 the closure according to FIG. 1, wherein a compression mould force and a holding ring are also shown broken away.

There can be seen in FIG. 1 a closure cap 1 which has a cap casing 2 and a cap base 3 and which as screw closure is equipped with an internal thread 8. In addition, two sealing elements 5, 6 can be seen which are in the form of annular, substantially axially extending (substantially hollow cylindrical) pins 5, 6. The radially inner pin 5 is provided with an outward swelling or a projection which can enter into sealing engagement with a container neck, specifically e.g. a PET bottle neck on its inside, if the external diameter of this pin 5 or of the external projection of same is greater than the internal diameter of the container. Moreover, a so-called external seal 6 is provided the internal diameter of which is smaller than the external diameter of a corresponding container neck and which is thus pulled over the upper outer edge of the bottle neck and clamped when the closure is screwed on.

The whole inner surface of the cap base 3 radially inside the inner sealing pin 5 (which simultaneously also acts as a centring journal), including the cylindrical inner surface of the sealing pin 51 is coated with an oxygen-absorbing compound 4. For better connection between the compound 4 and the cap base 3 as well as the sealing pin 5, an annular projection 7 with a slightly swallowtail cross-section is provided on the cap base and the inner surface of the sealing pin 5 displays at its lower free end a gradual diameter widening, with the result that a better adhesion is achieved in these areas due to the enlarged surface alone, wherein the annular pin 7, due to its swallowtail cross-section, moreover guarantees a form-locking between the compound 4 and the cap base 3. The gradual diameter widening that can be seen at 11 of the inner surface of the sealing pin 5 forms in conjunction with the compound material 4 a type of labyrinth seal, with the result that also in the case of only a weak adhesion between the compound 4 and the material of the closure significant quantities of cleaning fluid or other fluid cannot penetrate the area between compound 4 and the remaining closure material. In a further embodiment of the invention, not shown and even further preferred, the coating 4 with the oxygen-absorbing compound also extends in axial direction over the free end of the sealing or centring pin 5 and completely covers the free end of this centring pin 5 also in radial direction. As a result, an even better seal between sealing pin and oxygen-absorbing coating and a further improved adhesion between the material of the cap and the oxygen-absorbing coating is achieved.

On its outside, the casing 2 also has ribs or a corrugation 9 which is to facilitate the gripping of the closure and the lower free end of the cap is formed as a guarantee strip 10 which tears when the closure is opened for the first time.

In FIG. 2 it is shown roughly diagrammatically how the compound 4 is introduced into the closure and distributed. There can be seen in the extensively broken-away representation an internal mould force 20 and an external holding ring 21 which are preferably axially movable independently of each other vis-à-vis the closure cap. In order to mould the compound 4 to the inner surface of the cap base and sealing strip 5, a drop with a sufficient quantity of the compound material is in general applied in hot, plastic state in the centre of the cap and the mould force 20, the outer contour of which corresponds to the inner contour of the finished moulded-on compound, is then introduced into the closure cap and thereby spreads out the hot, plastic compound material and distributes it in the space remaining between mould force and closure cap, which corresponds exactly to the shape of compound 4 in FIG. 1.

As the compound material is relatively hot when it is introduced and the mould force 20 must also be introduced with sufficient pressure into the closure cap in order to distribute the compound material as desired, there is in principle a risk that the sealing pin 5 will also be widened outward and the compound material would then possibly not reach as far as the free end of this pin. Moreover, the sealing pin would then not have the desired final size. To this end, a holding or supporting ring 21 is provided which is introduced into the closure cap simultaneously with or else prior to the mould force 20 and which supports the sealing ring 5 from the outside when the internal mould force 20 compresses the compound material 4 on the cap base and the cylindrical inner surface of the sealing pin 5.

1. Closure cap (1) for containers consisting of a cylindrical cap casing (2) and a cap base (3), and an annular seal (5, 6) extending from the inner surface of the cap for sealing engagement with a container neck, wherein the annular seal is formed in one piece with the closure cap, characterized in that the inner surface of the cap base (3) is coated radially inside the annular seal (5, 6) with an oxygen-absorbing compound which is composed of a material chemically related to the material of the closure.

2. Closure cap according to claim 1, characterized in that it has an annular or hollow cylindrical centring pin (5) extending substantially axially from the cap base, wherein the compound is applied to the cap base (3) radially inside the centring pin (5).

3. Closure cap according to claim 2, characterized in that the centring pin is formed as an internal seal entering into sealing engagement with the cylindrical inner surface of a container neck.

4. Closure cap according to claim 3 characterized in that the centring pin has on its outside an annular projection for the sealing engagement with the inner surface of a container neck.

5. Closure cap according to claim 2, characterized in that the compound (4) also extends over the cylindrical inner surface of the centring pin (5).

6. Closure cap according to one of claims 2 to 5, characterized in that the inner surface of the cap base (3) and/or the inner surface of a centring pin (5) has projections and, or recesses which are covered by or filled with the oxygen-absorbing coating.

7. Closure cap according to claim 6, characterized in that the lower inside edge of the centring pin (5) has a recess which is occupied by a corresponding projecting part of the oxygen-absorbing coating.

8. Closure cap according to claim 7, characterized in that the recess is annular with the result that the boundary surface between the centring pin and the oxygen-absorbing coating effectively forms a labyrinth seal in the area of the free end of the centring pin.

9. Closure cap according to claim 6, characterized in that projections starting from the cap base with a preferably slightly undercut cross-section are provided, which are completely covered with the coatings.

10. Closure cap according to claim 9, characterized in that the projection consists of an annular swallowtail profile.

11. Closure cap according to claim 5, characterized in that the free end of the sealing pin has on its inside one or more diameter graduations, wherein the compound extends over the graduations and preferably up to the free end of the centring pin in order to achieve a labyrinth seal between compound and centring pin.

12. Closure cap according to claim 6, characterized in that the inner surface of the sealing pin and/or of the cap base is corrugated.

13. Closure cap according to claim 6, characterized in that the oxygen-absorbing coating projects in axial direction over the free end of the inner sealing pin and covers the free end of the sealing pin in radial direction.

14. Closure cap according to claim 1, characterized in that an annular seal (6) is provided which is formed for the engagement with an end-surface and/or the upper edge or the outer surface bordering the upper edge of a container.

15. Closure cap according to claim 1, characterized in that it has an internal thread (8).

16. Closure cap according to claim 1, characterized in that the cap casing (2) is provided at its lower end with a guarantee strip (10).

17. Process for the production of a closure according to claim 6, in which firstly a closure cap (1) with at least one annular seal moulded on in one piece is produced by injection-moulding, characterized in that a predetermined quantity of an oxygen-absorbing compound which is composed substantially of a material chemically related to the material of the closure is applied to the cap base in a hot plastic state and placed under pressure radially inside the annular seal by a mould force (20) to be introduced into the cap (1) and thereby moulded to the inner contour of the cap.

18. Process according to claim 17, characterized in that sealing and/or centring elements present in the cap which engage with the compound compressed by the mould force (20) are fixed or supported by additional holders (21) surrounding the mould force.

19. Process for the production of a closure according to claim 1, in which firstly a closure cap (1) with at least one annular seal moulded on in one piece is produced by injection-moulding, characterized in that a predetermined quantity of an oxygen-absorbing compound which is composed substantially of a material chemically related to the material of the closure is applied to the cap base in a hot, plastic state and placed under pressure radially inside the annular seal by a mould force (20) to be introduced into the cap (1) and thereby moulded to the inner contour of the cap.

20. Process for the production of a closure according to claim 7, in which firstly a closure cap (1) with at least one annular seal moulded on in one piece is produced by injection-moulding, characterized in that a predetermined quantity of an oxygen-absorbing compound which is composed substantially of a material chemically related to the material of the closure is applied to the cap base in a hot, plastic state and placed under pressure radially inside the annular seal by a mould force (20) to be introduced into the cap (1) and thereby moulded to the inner contour of the cap.
